(19) United States
(12) Patent Application Publication
(10) Pub. No.: US 2009/0046837 A1
(43) Pub. Date: Feb. 19, 2009

(54) SYSTEMS AND METHODS TO COORDINATE A MEDICAL RESPONSE TO AN INCIDENT

(76) Inventor: Daniel Thiel, Walnut Creek, CA (US)

Correspondence Address: FLIESLER MEYER LLP, 650 CALIFORNIA STREET, 14TH FLOOR, SAN FRANCISCO, CA, 94108, US

(21) Appl. No.: 12/192,859

(22) Filed: Aug. 15, 2008

Related U.S. Application Data
(60) Provisional application No. 60/965,207, filed on Aug. 17, 2007.

(51) Int. Cl. H04M 11/04

(52) U.S. Cl. 379/37

(57) ABSTRACT

Systems and methods of the present invention can be used to provide efficient and rapid coordinated medical responses to incidents, such as emergencies. In accordance with an embodiment, input(s) that specify a type and severity of an incident are received. In response thereto, medical personnel (persons) are informed of the incident and a need for the medical personnel to report to a facility where they can assist in a medical response to the incident. Replies are received from at least some of the persons. Information is automatically kept track of including, which persons are located at the facility, which persons are unavailable and which persons are en-route to the facility. Additionally, estimates of the amount of time it will take at least some of the persons (en-route to the facility) to arrive are automatically tracked.

### PRIORITY CLAIM

The present application claims priority under 35 U.S.C. 119(e) to Provisional Patent Application No. 60/965,207, filed Aug. 17, 2007, which is incorporated herein by reference.

### FIELD OF THE INVENTION

Embodiments of the present invention related to systems and methods for providing efficient and rapid coordinated medical responses to incidents, such as emergencies.

### BACKGROUND

In the healthcare industry, timely and proper communications could well be a matter of life and death. This is especially the case when dealing with emergencies, such as natural and man-made disasters, which result in a surge of patients requiring medical care. Nevertheless, a majority of hospitals report that they don't have “surge capacity” to respond effectively to epidemic illness, an act of terrorism, or the like.

For example, disasters require rapid assembly of emergency personnel and resources. However, not all disasters are the same, in that different disasters require different medical specialists to treat the victims of such disasters. More specifically, medical staffing will be different for responding to an earthquake, a chlorine gas leak, an anthrax contamination, a nuclear disaster, a fire, a hurricane, a plane crash, etc. For example, an earthquake may require surgeons, orthopedics, emergency response specialist and anesthesiologists. Staffing for responding to a chlorine gas leak may require pulmonary specialists, critical care specialists, emergency response specialists and anesthesiologists. Staffing for responding to an anthrax contamination may require infection disease specialists, critical care specialists, emergency response specialists and anesthesiologists. Staffing for responding to a nuclear disaster may require emergency response specialists, critical care specialists and hospitalists. Staffing for responding to a fire may require surgeons, burn specialists, plastic surgeons, emergency response specialists and anesthesiologists.

There is a need for improved collaborations between hospitals, doctors, and emergency personnel in a time and cost efficient manner. Specific embodiments of the present invention are directed to fulfilling this need.

### SUMMARY

Systems and methods of the present invention can be used to provide efficient and rapid coordinated medical responses to incidents, such as emergencies. In accordance with an embodiment, input(s) that specify a type and severity of an incident are received. In response thereto, medical personnel (persons) are automatically informed of the incident and a need for the medical personnel to report to a facility where they can assist in a medical response to the incident. Replies are received from at least some of the persons. Information is automatically kept track of including, which persons are located at the facility, which persons are unavailable and which persons are en-route to the facility. Additionally, estimates of the amount of time it will take at least some of the persons (en-route to the facility) to arrive or otherwise be available are automatically tracked.

Further embodiments, and the features, aspects, and advantages of the present invention will become more apparent from the detailed description set forth below, the drawings and the claims.

### BRIEF DESCRIPTION OF THE FIGURES

FIG. 1A illustrates a Main Screen of a command center, which can be displayed to a user, in accordance with specific embodiments of the present invention.

FIG. 1B illustrates an Activated Notification screen of a command center, which can be displayed to a user, in accordance with specific embodiments of the present invention.

FIG. 1C illustrates a Departments screen of a command center, which can be displayed to a user, in accordance with specific embodiments of the present invention.

FIG. 1D illustrates a Cancel Notification screen of a command center, which can be displayed to a user, in accordance with specific embodiments of the present invention.

FIG. 1E illustrates a Set Doctor Status screen of a command center, which can be displayed to a user, in accordance with specific embodiments of the present invention.

FIG. 2 is a high level block diagram that is useful for describing an environment in which embodiments of the present invention can be implemented.

FIG. 3 illustrates exemplary details of the host system of FIG. 2.

FIG. 4 is a high level flow diagram that is used to summarize computer implemented methods according to various embodiments of the present invention.

### DETAILED DESCRIPTION

Embodiments of the present invention can be used to replace old fashioned phone trees. More specifically, embodiments of the present invention can be used to get the right medical specialists to the right places, as soon as possible. This will save lives.

Embodiments of the present invention can be used to contact medical personnel that are needed to perform critical care in response to an incident, such as a natural or manmade disaster. For example, embodiments of the present invention can be used to notify appropriate hospital staff of a medical emergency, and of the need for such staff to report to a hospital or other facility. Such staff can include physicians and nurses, such as, but not limited to, floor, intensive care unit (ICU), operating room (OR) and recovery staff.

Embodiments of the present invention can also be used to notify allied health care facilities, such as, but not limited to, labs, pharmacies and x-ray facilities, of an incident and the need for services.

Further, embodiments of the present invention can also be used to notify non-medical personnel (also referred to as auxiliary personnel), such as plant operators, security personnel, food service personnel, housekeeping, laundry workers, and transport workers (e.g., ambulance drivers), whose services may be needed to enable a medical facility to operate effectively and efficiently.

Specific embodiments of the present invention enable contacted medical personnel (also referred to as “notified medical personnel”) to respond and tell a system if they are:—in the hospital, 30 minutes away, 60 minutes away, or unavailable. More specifically, certain embodiments of the present invention relate to a countdown timer that monitors when responders will be available.

In accordance with specific embodiments of the present invention, updates are sent to responders from time-to-time (periodically, such as every 15 minutes, or aperiodically) to confirm status of the responders, as well as to keep responders updated as to the overall status of the incident, and more generally, to keep the medical community aware of what is transpiring.

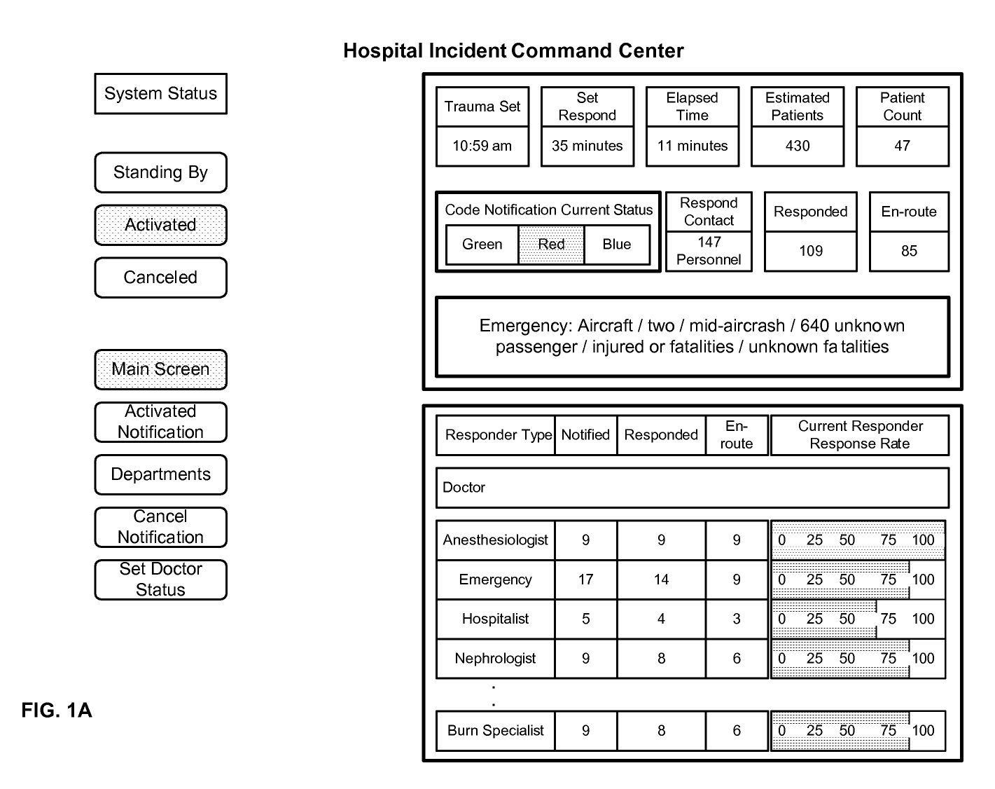

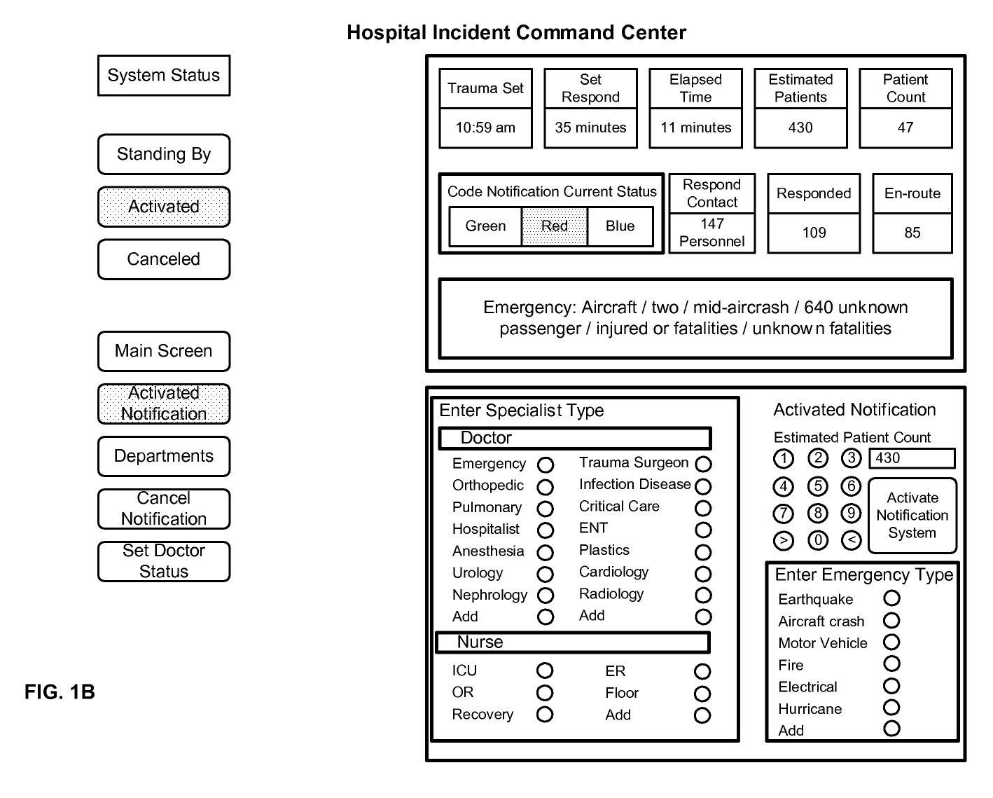

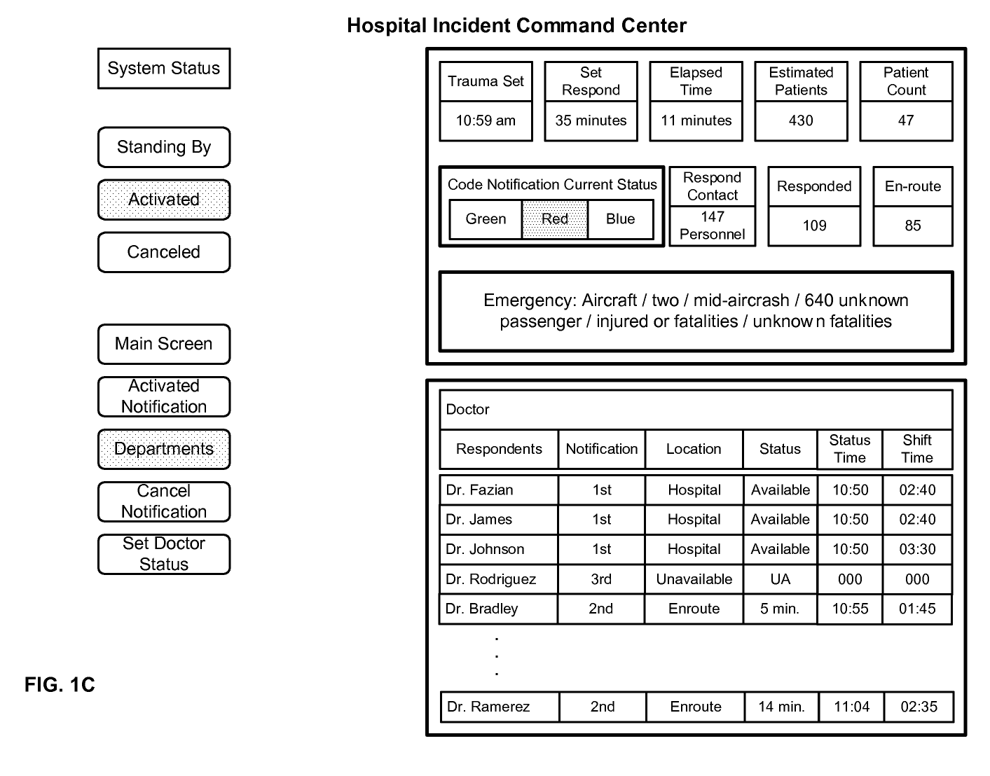

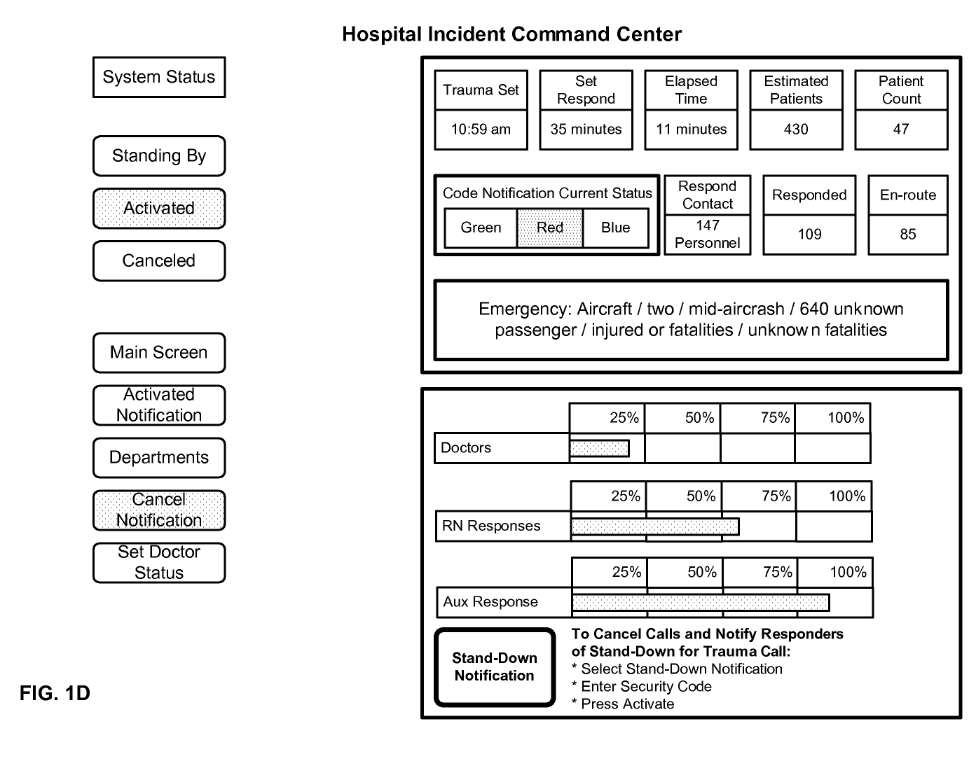

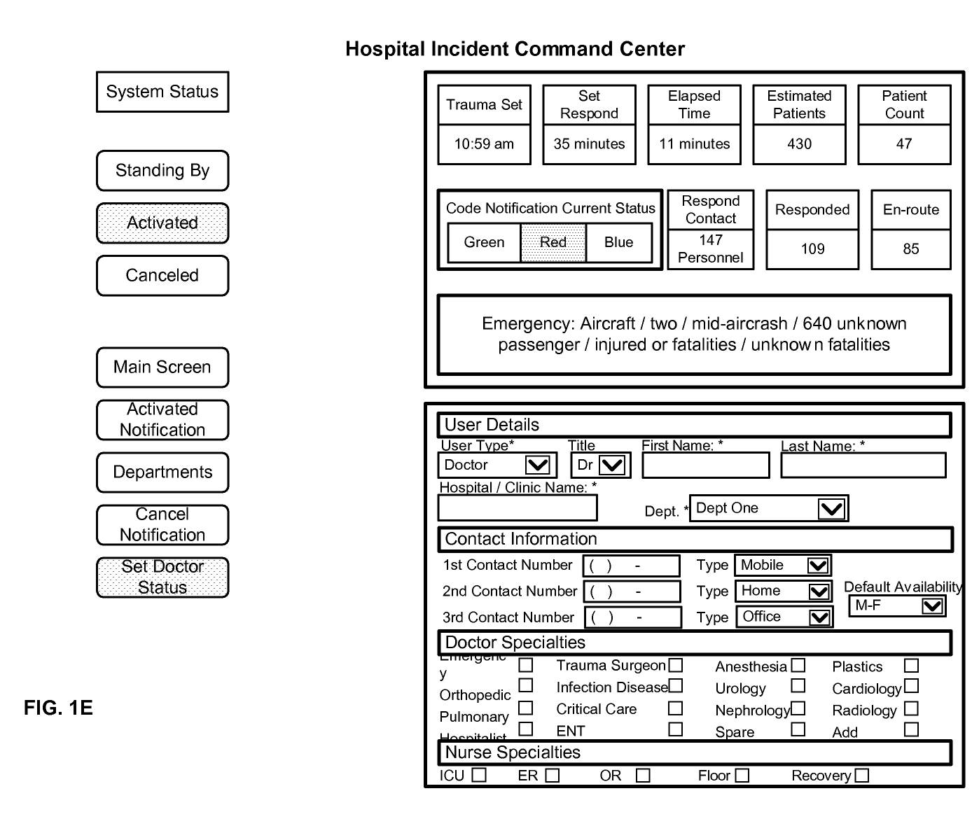

FIGS. 1A-1E illustrate various Hospital Incident Command Center screens that can be displayed to a user that is assisting in the coordination of a medical response to an incident. Shown in FIGS. 1A-1E are various fields that can be displayed to the user. The user can populate (i.e., enter information into) some of the fields based on what they know about the incident, and further fields are populated based on what the user entered into other fields. Still other fields can be populated based on responses received from medical persons, as well as based on countdown clocks.

FIGS. 1A, 1B, 1C, 1D and 1E, illustrate, respectively, a Main Screen, an Activated Notification Screen, a Departments Screen, a Cancel Notification Screen and a Set Doctor Status screen, that can be displayed to a user, in accordance with embodiments of the present invention. Portions of the screens can be common to multiple screens, and other portions of the screens are specific to one screen. The Main Screen of FIG. 1A will first be discussed, followed by a discussion of the other screens. Where portions of a screen are common to a previously discussed screen, such common portions are not described again, to avoid duplication of discussion.

Referring to the top right of FIG. 1A, fields include Trauma Set, Set Response, Elapsed Time, Estimated Patients and Patient Count. The Trauma Set field can specify the time at which an incident occurred. The Set Response can be a desired response time. The Elapsed Time can be the time that has elapsed since the Trauma Set time. The Estimated Patients can be the total number of patients that are expected to be in need of treatment as a result of the incident. The Patient Count can be the total number of patients so far definitively identified. The just described fields are also included in the screens of FIGS. 1B-1E.

A further field shown in FIG. 1A is the Code Notification Current Status field, which can be identified as being one of multiple options, e.g., Green, Red and Blue, each of which colors has a specified meaning. For example, green can indicate that there are currently no emergencies for which a response is needed, red can indicate that an emergency response is needed, and blue can indicate that an emergency notification has been canceled. These fields are also included in the screens of FIGS. 1B-1E.

Additional fields shown in FIG. 1A include a Respond Contact field, a Responded Field and an En-Route field. The Respond Contact field can specify the total number of medical personnel that have been contacted to respond to the incident. Such medical personnel include a plurality of persons, each of which preferably has a set of skills known by the system. The Responded field can specify how many of the persons (also referred to as respondents) that have been notified have responded to a request for them to report to a facility. Such a facility can be a hospital, but need not be. For example, it is possible that a facility be a location of a disaster, e.g., a building where a fire occurred. The En-Route field can specify the number of respondents that are En-Route to the facility. Another possible field, not shown, is one that specifies how many respondents are already located at the facility.

A further field shown in FIG. 1A (shown below the Code Notification Current Status field) is one that identifies the incident and may include details about the incident. In FIG. 1A the incident is identified as an emergency, and more specifically, a mid-air crash between two aircraft. A total number of possible passengers is also identified. Also identified, if known, would be the total number of known injured and fatalities. This field is also included in the screens of FIGS. 1B-1E.

Also shown in FIG. 1A are fields which identify the types of persons that have been notified of the incident, as well as how many of each type have been notified, how many of each type have responded and how many of each type are en-route. For each responder-type, the current responder response rate can also be tracked, and graphically displayed to the user. In FIG. 1A, the Responder Types shown are all doctors. Other Responder Types can be, e.g., different types of nurses. Various types of nurses can include, but are not limited to, intensive care unit (ICU), operating room (OR), recovery, emergency room (ER) and floor nurses. Additionally, responder-types can also include auxiliary personnel, such as plant operators, security personnel, food service personnel, housekeeping, laundry workers, and transport workers (e.g., ambulance drivers), whose services may be needed to enable a medical facility to operate effectively and efficiently.

FIG. 1A also shows various “buttons” on the left side that can be pressed or otherwise selected by the user, e.g., using a mouse, trackball, touch screen, arrow keys, etc. Such buttons include Standing By, Activated and Canceled, and thus, may be referred to a System Status buttons or selections. The current status is preferably highlighted, shaded, made red, or otherwise made identifiable to the user. In FIG. 1A the Activated button is shown as being shaded, indicated that the system has been activated.

FIG. 1A also shows additional “buttons” that can enable the selection of specific screens and specific functions, where such buttons include Main Screen, Activate Notification, Departments, Cancel Notification and Set Doctor Status. The screen currently being displayed is preferably highlighted, shaded, made red, or otherwise made identifiable to the user. In FIG. 1A the Main Screen button is shown as being shaded, indicating that the Main Screen is being displayed.

At the bottom right of FIG. 1A is a table that specifies different Responder types of Doctors (e.g., Anesthesiologist, Emergency, Hospitalist, Nephrologist, Burn Specialist, etc.). This table can also specify different Responder types of Nurses (e.g., floor, intensive care unit (ICU), operating room (OR), recovery staff). Also shown in the table are the number of each Responder type that has been Notified, have Responded to the notification, and have indicated they are En-Route. In one embodiment, the number of each type of Responder Type that is to be notified is automatically specified by the system, using pre-programmed algorithms, based on the estimated patients, type of incident and/or the severity of the incident. An authorized user can modify such numbers, or alternatively, can be responsible for providing such numbers in the first place.

Additionally, shown near the bottom right of FIG. 1A is a Current Responder Response Rate graph (a bar graph in this instance) that illustrates the Response Rate of the Responders in a manner that a user can quickly and easily comprehend (e.g., a rate between 0 and 100% of Responders have actively responded). Additionally, or alternatively, a similar graph can show a percentage of Responders that are En-route.

FIG. 1B shows an Activated Notification Screen, which is displayed when the Activated Notification button is selected by a user. Shown near the bottom right of FIG. 1B is an Enter Specialist Type area that a user can use to specify and/or modify which specialist should be notified for a specific emergency type. Another area allows an Emergency Type to be entered. A further area allows an Estimated Patient Count to be entered.

FIG. 1C shows a Departments Screen, which is displayed when the Departments button is selected by a user. Shown near the bottom right of FIG. 1C is a table that specifies information about Respondents that have been notified, including a Notification quantity, Location (e.g., hospital, unavailable and en-route), Status (e.g., available, unavailable/UA, or if en-route, how long it will take to get to the facility/location where they are needed (e.g., hospital). Status Time information is also provided, which specifies when the Respondent is estimated to be located at the facility where they are needed. If the Respondent is already at the facility/location where they are needed, the Status Time will be the same as the current time. If the Respondent is en-route to the facility/location, and it is expected that they will arrive in, e.g., 14 minutes, then the Status Time will be the current time plus 14 minutes. Additionally, Shift time information is provided, which species when the Respondent's shift is to start.

FIG. 1D shows a Cancel Notification Screen, which includes a Stand-Down Notification button that can be used to cancel (also referred to as “stand-down”) a previously requested Response. By selected this button, all the Doctors, Nurses and Auxiliary personnel that were previously notified to respond to an incident can be notified to stand-down. The bar-graph above the Stand-Down Notification button can illustrate to the user the percentage of the various Respondent Types that have been notified of an incident, and can also illustrate the percentage of the various Respondent Types that have been successfully notified to stand-down. In another embodiment, a user can stand-down a certain percentage of each Respondent Type, e.g., if it determined that more respondents than necessary were contacted and available. In one embodiment, the user can do this by moving the bars on the bar graph, e.g., using a cursor, mouse, touch screen, etc.

FIG. 1E shows a Set Doctor Status screen which can be used to enter and edit details about Doctors and Nurses into the system. A similar screen can exist for auxiliary personnel. Multiple contact numbers can be entered for each Doctor, Nurse, etc., and when such personnel need to be notified about an incident, the 1^{st} contact number can be tried first, followed by the 2^{nd} contact number, etc. In accordance with an embodiment, similar fields exist for entering email addresses, facsimile numbers, and the like, so that personnel can be notified of an incident in other manners besides telephone calls, as will be appreciated from the discussion below.

Systems and methods of the present invention can be used to coordinate a medical response to an incident. Such an incident can be, but is not limited to, a natural or man-made disaster, a terrorist attack, a military attack, a construction accident, or any other medical emergency, additional examples of which were mentioned above.

In accordance with specific embodiments of the present invention, a system of the present invention informs medical personnel of the incident and a need for the medical personnel to report to a facility (e.g., hospital) where they can assist in the medical response to the incident. Such medical personnel include a plurality of persons. The notification can also request a reply from the medical personnel. Such notifications can be sent via multiple different types of communications systems to multiple different types of communications devices, such as, but not limited to, landline telephones, wireless communications devices (e.g., cell phones, persons data assistants, pagers, etc.), to devices via electronic mail, via facsimile, via text messages, via voice messages, etc.

The system of the present invention can also receive replies from medical personnel. Such a reply can include an indication that the person responding (who may be referred to as a respondent) is already located at the facility. If the respondent is not located at the facility, the reply can include an estimate of an amount of time it will take the person (i.e., the respondent) to arrive at the facility. Another possible reply is an indication that the person is unavailable. In specific embodiments, the request message can instruct the recipient of the message (i.e., the respondent) how to reply, such that useful information is included in the reply, examples of which are discussed above. For example, assume a notification is a voice recording sent to a user's cell phone, the voice recording may instruct the user to press “1” if they are already at the facility, press “2” if they are en-route to the facility and press “3” if they are unavailable. If the user presses “2”, they may then be prompted to enter their estimated time of arrival at the facility. Similar interactions can take place via email, text messaging, web portals, etc. In accordance with an embodiment, personnel are assumed to be unavailable until a reply is received from the personnel. In accordance with an embodiment of the present invention, global positioning system (GPS), or other positioning technology, can be used to estimate and/or assist in the estimates of time of arrival. In certain embodiments, time of availability can be tracked instead of (or in addition to) time of arrival, since it may take certain personnel some time to be available after they arrive at a facility (e.g., they may need to park their car, change their clothes and/or wash-up, etc.).

In accordance with specific embodiments of the present invention, the system can keep track of information including, but not limited to, which persons are located at the facility, which persons are en-route to the facility, estimates of the amount of time it will take each person en-route to the facility to arrive at the facility, as well as which persons are unavailable.

The system can also display such tracked information. FIG. 1A, discussed above, illustrates an example of what can be displayed. Additional and/or alternative information can also be displayed, as will be appreciated from the description herein, including a description of screens of FIGS. 1B-1E.

In accordance with specific embodiments, the system can automatically update estimates of the amount of time it will take the persons en-route to the facility to arrive at the facility. Such updating can be performed based on time estimates included in replies, as well as elapsed times since the replies. In certain embodiments, each person en-route to the facility is associated with a countdown timer, wherein the countdown timer is used to estimate the amount of time it will take the person to arrive at the facility. Each countdown timer can be implemented in software, firmware, hardware, or combinations thereof. A value of countdown timer may be initially set based on information received in a reply from a respondent. The value of the countdown timer can thereafter be adjusted (e.g., reduced) based on the elapsed time since the countdown timer was set.

The system can automatically send status update requests to persons that are en-route to the facility, and receive replies to the status update requests. The system can also update estimates of the amount of time it will take the persons en-route to the facility to arrive at the facility, based on the received replies to the status update requests. This can include, e.g., updating the countdown timers based on received replies to status update requests. An update to the countdown timer can either increase or decrease the value of the countdown timer, depending on the reply to a status update request.

The system can also send updates regarding the incident to persons en-route to the facility, to thereby keep personnel abreast of the situation.

The system can store information about a plurality of different types of incidents, and allow a user to select among the plurality of different types of incidents. Exemplary different types of incidents can include, but are not limited to, fires, hurricanes, chemical spills, air-born chemical contamination, floods, earthquakes, etc. Additionally, the system can automatically identify which and how many medical personnel should be informed of the incident, based on the selected type of incident, and its severity. The system can also accept information about incidents not stored in the system, and allow a user to define types and numbers of medical personnel that should be notified. Additionally, the system can allow an authorized user to alter or override pre-stored information about types of possible incidents.

The system can also allow a user to specify a severity of an incident. This can include, e.g., allowing a user to select from a sliding scale (e.g., between 1 and 10), allowing a user to enter numeric estimates of patients, as well as allowing a user to enter information about the scale of the incident. The system can take such information about the severity of the incident into account when identifying which and how many medical personnel should be notified about the incident.

When the system receives indications that persons are unavailable (and/or have not responded), the system can, when appropriate, inform additional medical personnel of the incident and a need for the additional medical personnel to report to a facility, based on how many and which persons previously informed of the incident indicated that they are unavailable (and/or have not responded).

In accordance with certain embodiments of the present invention, the system can produce a schedule for the medical response to the incident, where the schedule includes information about when specific persons should report to the facility, where some persons should arrive prior to other persons. For example, the system may request that certain types of first responders report to a facility first or within a specified time, and request that other types of medical specialists (e.g., those that work in a post operative unit) arrive a little bit later (e.g., between certain times), so that all personnel are not arriving at the exact same time, potentially causing certain bottlenecks. The system can also create schedules for the medical response to the incident, based on replies received from respondents. For example, where respondents are already located at the facility, they may be scheduled to report for a first shift, whereas respondents that are en-route and will not be available for at least a certain amount of time may be scheduled to report for a later shift.

It is also possible that the system can inform specific persons en-route to a facility that they need not report to the facility, e.g., because enough other persons having similar skills have already reported to the facility and/or are en-route to the facility ahead of the specific persons. In such a case, the system may tell such persons to permanently stand-down, remain on-call, or to arrive at a later time when they will be needed.

A system of the present invention can include one or more database to store information about medical personnel, the medical personnel including a plurality of persons. The system can also include a transceiver subsystem. The transceiver subsystem can inform medical personnel of the incident and a need for the medical personnel to report to a facility where they can assist in the medical response to the incident, and request a reply from the medical personnel. Additionally, the transceiver subsystem can receive replies from at least some of the persons, wherein each reply includes an indication that the person responding is already located at the facility, an estimate of an amount of time it will take the person to arrive at the facility, or an indication that the person is unavailable. Additionally, the system can include a tracking subsystem to keep track of information including which persons are located at the facility, which persons are en-route to the facility, estimates of the amount of time it will take each person en-route to the facility to arrive at the facility, and which persons are unavailable. Also, as explained above, the system may associate a countdown timer with personnel that are en-route to a facility/location.

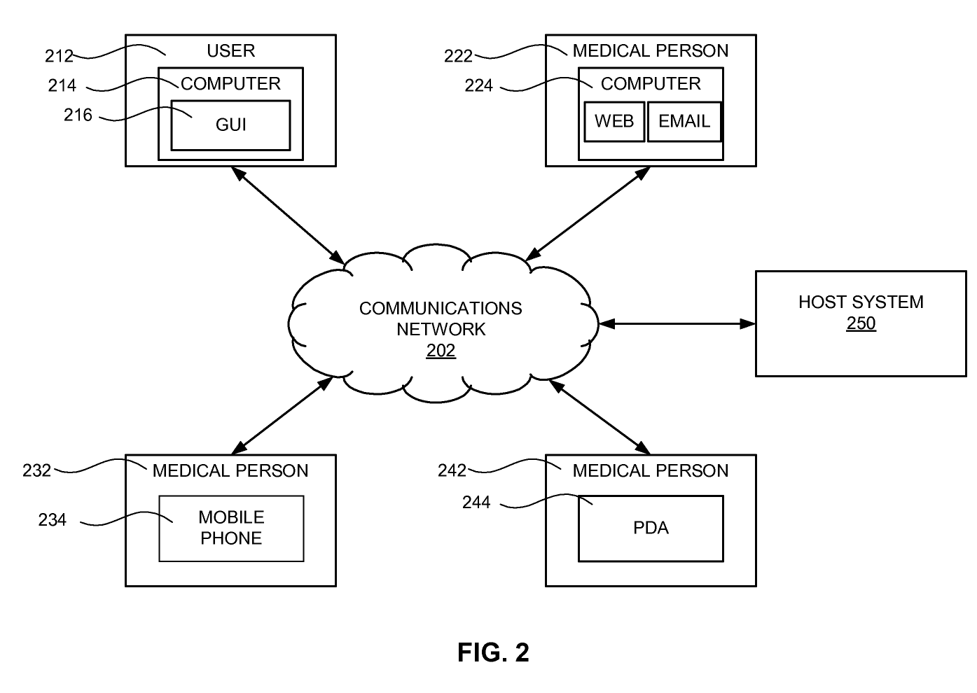

FIG. 2 is a high level block diagram that is useful for describing an environment in which embodiments of the present invention can be implemented. Shown in FIG. 1 is a user 212 and medical persons 222, 232, 243, each of which is represented by a block. Each of these entities is shown as having access to a respective communications device, such as a computer 224, a mobile phone 234, personal data assistant 244, or other communications device (e.g., a landline telephone) not shown. The computer 212 of the user 212 can include a display monitor that displays a graphical user interface 216, such as the hospital incident command center interface shown in FIGS. 1A-1E.

The computer 224 of a medical person can be capable of receiving a notification about an incident via a web browser, web portal, or an electronic mail box. The mobile phone 234 can be capable or receiving a notification about an incident via a voice message or a text message, or via email if the phone 234 can accept and/or access email. Similarly, the PDA 244 can be capable or receiving a notification about an incident via a text message, an email, a website, etc. Through such communications devices, the user 212 can communicate with medical personnel 222, 232, 242 etc, via the communications system 202. Additionally, the user 212 can communicate with the host system 250, which supports the capabilities of the present invention. While the user 212 and the host system 250 are shown as being geographically separated, they can be co-located, depending on where the host system is being hosted. For example, the server of the host system 250 can be located within a hospital facility, or offsite, depending on whether the hospital wants to be responsible for maintaining the server. It also possible that a hospital maintains a server of the host system 250, and that a redundant server be located offsite (and/or onsite). It is also possible that the computer 214 of the user is the host system, or at least a part of the host system. Further, it is also within the scope of the present invention that many of the user functions mentioned above be completely automated (or at least semi-automated) and performed by the computer 214 and/or the host system 250.

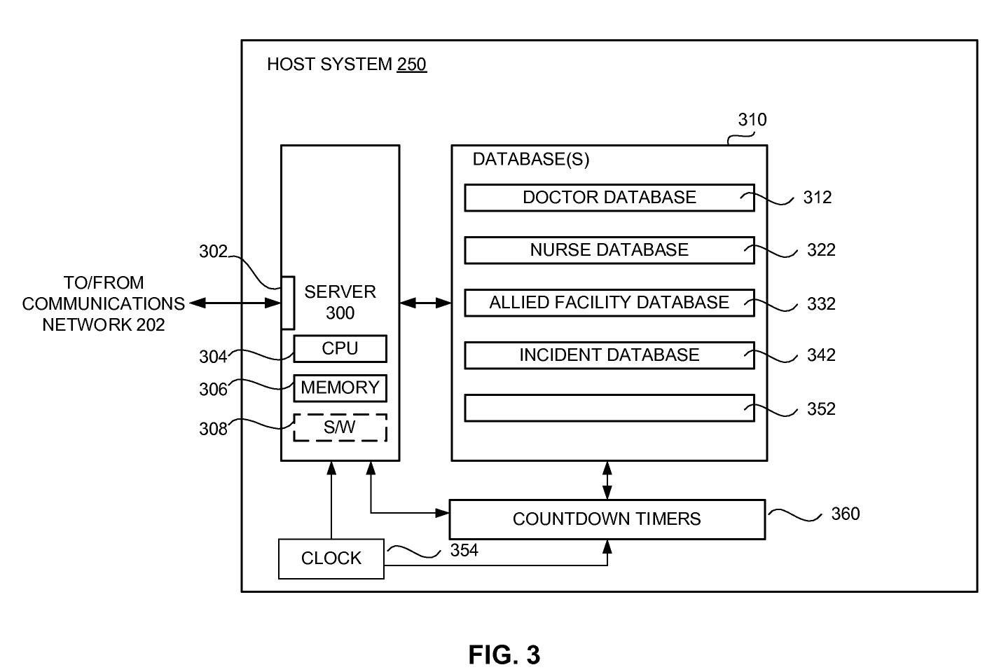

Exemplary details of the host system 250 are shown in FIG. 3. Referring to FIG. 3, the host system 250 can include a server 300 (e.g., a web server) that includes or has access to a communications interface 302, one or more processor 304, memory 306, software 308, a clock 354, countdown timers 360, and one more database 310. The communications interface 302 can allow software and data to be transferred between the host system 250 and external systems. Examples of the communications interface 302 include a modem, a network interface (such as an Ethernet card), a communications port, a PCMCIA slot and card, etc. Software and data transferred via the communications interface 302 are in the form of signals which may be electronic, electromagnetic, optical or other signals capable of being received by communications interface. These signals are provided to communications interface 302 via a communications path, which can be implemented using wire or cable, fiber optics, a phone line, a cellular phone link, an RF link and other communications channels. Although not shown, the host system can also include various codecs, and the like. Additionally, the host system can include capabilities of converting messages entered by the user via a keyboard into voice messages receivable and listenable via a mobile phone or landline telephone.

Software for performing the features of the present invention described above can be stored on machine readable medium. In this document, the terms “machine readable medium”, “computer program medium” and “computer usable medium” are used to generally refer to media such as removable storage drive a hard disk installed in hard disk drive, and the lie. These computer program products are means for providing software 308 to the host system 350. Computer programs (also called computer control logic) are stored in memory 306 or removable storage units (not shown). Computer programs may also be received via the communications interface 302. Such computer programs, when executed, enable the host system 250 to implement specific features of the present invention as discussed herein. In particular, the computer programs, when executed, enable the one or more processor 304 to implement the features of the present invention. Where the invention is implemented using software, the software 308 may be stored in a computer program product and loaded into the host system 250 using a removable storage drive, a hard drive or the communications interface.

The database 310 can be made up of separate databases, or separate portions of the database 310. Exemplary portions of the database, or separate databases, include a doctor database 312 (or database portion), a nurse database 322 (or database portion), an allied facility database 332 (or database portion), as well as additional databases (or database portions), which can include information, e.g., about non-medical personnel, such as janitors, food service workers, laundry workers, etc. The doctor database 312 can store information (e.g., profiles) about each doctor, including, but not limited to, their name, address, contact information and medical specialty (or specialties). The nurse database 322 can store similar information about the nurses. One or more other database (or other database portion) can include information about non-medical personnel that may be needed to help assist with responding to an incident and/or help run a medical facility. Also shown is an incident database 342, which can store information about various different types of possible incidents that may occur. In information stored within the various databases can be used by a scheduler (e.g., scheduling software) to produce the various schedules discussed above.

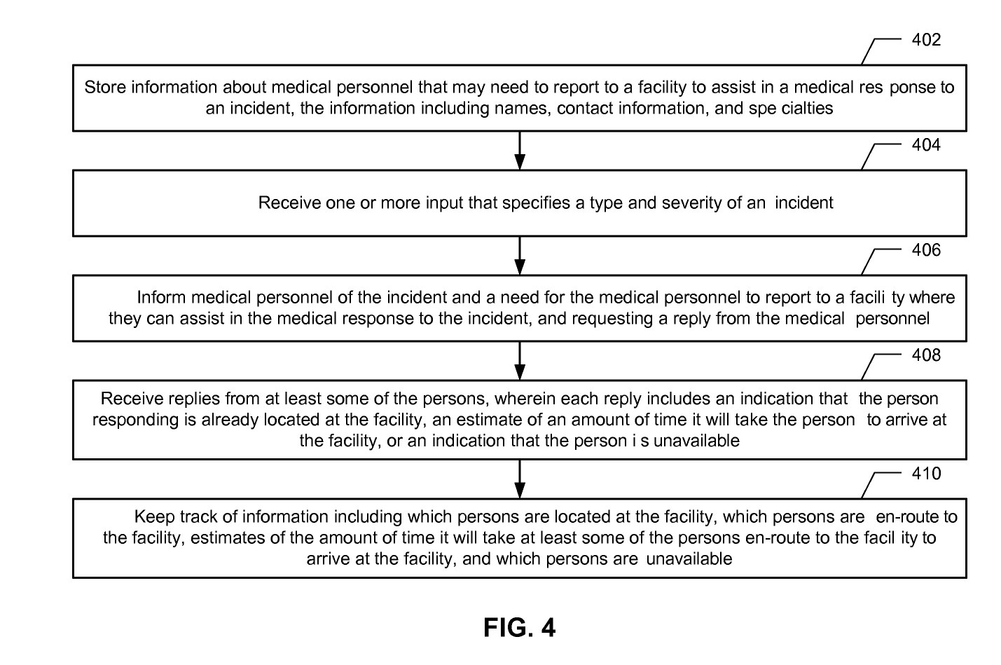

The high level flow diagram of FIG. 4 will now be used to summarize the various methods of the present invention, many of which are computer implemented methods for coordinating a medical response to an incident. Referring to FIG. 4, at step 402 information about medical personnel (that may need to report to a facility to assist in a medical response to an incident) is stored. Such information can include, e.g., names, contact information, specialty, and the like. Additional types of information that may be stored are described above.

At step 404, one or more input that specifies a type and severity of an incident is received. Such information may be entered by a user into a computer, e.g., using one of more the screens described above with reference to FIGS. 1A-1E. Step 404 can include presenting different types of incidents to a user via a display, where each incident requires a different type of medical response. The user can then be allowed to select among the different types of incidents. In specific embodiments, based on the selected type of incident, as well as a severity (e.g., scale) of the incident, a computer system can automatically identify which medical personnel should be informed of the incident.

At step 406, medical personnel (persons) are informed of the incident and a need for the medical personnel to report to a facility where they can assist in the medical response to the incident. Additionally, a reply from the medical personnel is requested. At step 408, replies are received from at least some of the persons, wherein each reply includes an indication that the person responding is already located at the facility, an estimate of an amount of time it will take the person to arrive at the facility, or an indication that the person is unavailable. Messages informing medical person of their need to report (sent at step 406), and replies to such message (received at 408) can be via wireless communications, electronic mail and/or facsimile, but are not limited thereto.

At step 410, information is kept track of including which persons are located at the facility, which persons are en-route to the facility, estimates of the amount of time it will take at least some of the persons en-route to the facility to arrive at the facility, and which persons are unavailable. In accordance with specified embodiments, such tracked information can be displayed to a user, as was described above.

In accordance with specific embodiments of the invention, steps 406, 408 and 410 are automated, meaning they are automatically performed by a computer with no or minimal input from a user. This does not mean that the user can not monitor or observe what is occurring. Further, a user can even override certain functions, if the user is so authorized. Additionally, a user may need to specify at what point medical personnel should be initially alerted of an incident. The point is, that one an incident has been identified at step 404, and it has been determined that medical personnel are needed, a computer system can efficiently and effectively cause steps 406, 408 and 410 to occur, so that a medical response can occur in an efficient and effective manner.

In accordance with specific embodiments, step 410 can include automatically updating estimates of the amount of time it will take the persons en-route to the facility to arrive at the facility, based on time estimates included in replies and elapsed times since the replies. This can be accomplished by associating each person en-route to the facility with a countdown timer that is used to estimate the amount of time it will take the person to arrive at the facility.

In accordance with specific embodiment, status update requests are automatically sent to persons that are en-route to the facility, and replies to the status update requests are received. In this manner, step 410 can include updating estimates of the amount of time it will take the persons en-route to the facility to arrive at the facility, based on the received replies to the status update requests.

Additionally, in certain embodiments, based on how many persons previously informed of the incident indicated that they are unavailable, additional medical personnel can be automatically informed of the incident and a need for the additional medical personnel to report the facility. Further, as was explained above, specific persons en-route to the facility may be informed that they need not report to the facility, because enough other persons having similar skills have already reported to the facility and/or are en-route to the facility ahead of the specific persons.

Additionally, in certain embodiments, a schedule for the medical response to the incident is automatically produced, where the schedule includes information about when specific persons should report to the facility, where some persons should arrive prior to other persons. In such embodiments, step 404 can include informing persons when they should report to the facility. It is also possible that a schedule for the medical response to the incident is based and/or updated in view of replies received at step 408.

Many features of the present invention can be performed in, using, or with the assistance of hardware, software, or combinations thereof. Consequently, features of the present invention may be implemented using a processing system (e.g., including one or more processors), as was mentioned above.

Features of the present invention can be implemented in, using, or with the assistance of a computer program product which is a storage medium (media) having instructions stored thereon/in which can be used to program a processing system to perform any of the features presented herein. The storage medium can include, but is not limited to ROMs, RAMs, EPROMs, EEPROMs, DRAMs, VRAMs, flash memory devices, or any type of media or device suitable for storing instructions and/or data.

Stored on any one of the machine readable medium (media), features of the present invention can be incorporated in software for controlling the hardware of a processing system, and for enabling a processing system to interact with other mechanism utilizing the results of the present invention. Such software may include, but is not limited to, application code, device drivers, operating systems and execution environments/containers.

While various embodiments of the present invention have been described above, it should be understood that they have been presented by way of example, and not limitation. It will be apparent to persons skilled in the relevant art that various changes in form and detail can be made therein without departing from the spirit and scope of the invention.

Embodiments of the present invention have been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the claimed invention. One skilled in the art will recognize that these functional building blocks can be implemented by discrete components, application specific integrated circuits, processors executing appropriate software and the like or any combination thereof.

The breadth and scope of the present invention should not be limited by any of the above-described exemplary embodiments, but should be defined only in accordance with the following claims and their equivalents.

What is claimed is:

1. A computer implemented method for coordinating a medical response to an incident, comprising:
(a) receiving one or more input that specifies a type and severity of an incident;
(b) informing medical personnel of the incident and a need for the medical personnel to report to a facility where they can assist in the medical response to the incident, and requesting a reply from the medical personnel, the medical personnel including a plurality of persons;
(c) receiving replies from at least some of the persons, wherein each reply includes
an indication that the person responding is already located at the facility,
an estimate of an amount of time it will take the person to arrive at the facility, or
an indication that the person is unavailable; and
(d) keeping track of information including
which persons are located at the facility,
which persons are en-route to the facility,
estimates of the amount of time it will take at least some of the persons en-route to the facility to arrive at the facility, and
which persons are unavailable;
wherein steps (b), (c) and (d) are automated.

2. The computer implemented method of claim 1, further comprising:
(e) displaying the tracked information.

3. The computer implemented method of claim 1, further comprising, prior to step (a), storing information about medical personnel that may need to report to a facility to assist in a medical response to an incident, the information including for each medical personnel person:
name;
contact information; and
specialty.

4. The computer implemented method of claim 1, wherein step (b) includes informing the medical personnel of the incident using at least some of the following:
landline telephones;
wireless communications;
electronic mail; and
facsimile.

5. The computer implemented method of claim 1, wherein step (d) includes automatically updating estimates of the amount of time it will take the persons en-route to the facility to arrive at the facility, the updating being performed based on time estimates included in replies and elapsed times since the replies.

6. The computer implemented method of claim 5, wherein step (d) includes associating each of at least some of the persons en-route to the facility with a countdown timer, wherein the countdown timer is used to estimate the amount of time it will take the person to arrive at the facility.

7. The computer implemented method of claim 5, further comprising:
automatically sending status update requests to persons that are en-route to the facility;
receiving replies to the status update requests from at least some of the persons that are en-route to the facility; and
wherein step (d) includes updating estimates of the amount of time it will take the persons en-route to the facility to arrive at the facility, based on the received replies to the status update requests.

8. The computer implemented method of claim 7, wherein step (d) includes:
associating each of at least some of the persons en-route to the facility with a countdown timer, wherein the countdown timer is used to estimate the amount of time it will take the person to arrive at the facility; and
updating the countdown timers based on received replies to status update requests.

9. The computer implemented method of claim 1, further comprising:
automatically sending updates regarding the incident to persons en-route to the facility.

10. The computer implemented method of claim 1, further comprising, prior to step (a):
presenting a plurality of different types of incidents, each of which requires a different type of medical response;
allowing a user to select among the plurality of different types of incidents; and
automatically identifying which medical personnel should be informed of the incident at step (b) based on the selected type of incident.

11. The computer implemented method of claim 10, wherein:
the allowing step includes allowing the user to specify a scale of the incident; and
the automatically identifying step takes into account the scale of the incident to determine how many medical personnel should be informed of the incident at step (b).

12. The computer implemented method of claim 1, further comprising:
automatically informing additional medical personnel of the incident and a need for the additional medical personnel to report the facility, based on how many persons previously informed of the incident are unavailable.

13. The computer implemented method of claim 1, further comprising, prior to step (b):
producing a schedule for the medical response to the incident, the schedule including information about when specific persons should report to the facility, where some persons should arrive prior to other persons; and
wherein step (b) includes informing persons when they should report to the facility.

15. The computer implemented method of claim 1, further comprising, producing a schedule for the medical response to the incident, based on received replies.

16. The computer implemented method of claim 1, further comprising:
automatically informing specific persons en-route to the facility that they need not report to the facility, because enough other persons having similar skills have already reported to the facility and/or are en-route to the facility ahead of the specific persons.

17. A system for coordinating a medical response to an incident, comprising:
one or more database to store information about medical personnel, the medical personnel including a plurality of persons;
a transceiver subsystem
to inform medical personnel of the incident and a need for the medical personnel to report to a facility where they can assist in the medical response to the incident, and requesting a reply from the medical personnel, the medical personnel including a plurality of persons; and
to receive replies from at least some of the persons, wherein each reply includes an indication that the person responding is already located at the facility, an estimate of an amount of time it will take the person to arrive at the facility, or an indication that the person is unavailable; and
a tracking subsystem to keep track of information including which persons are located at the facility, which persons are en-route to the facility, estimates of the amount of time it will take each person en-route to the facility to arrive at the facility, and which persons are unavailable.

18. The system of claim 17, further comprising countdown timers, each of which can be associated with a person en-route to the facility, wherein the countdown timer is used to estimate the amount of time it will take the person to arrive at the facility.

19. The system of claim 18, wherein the countdown timers are automatically updated based on replies received from persons en-route to the facility.

20. The system of claim 17, wherein:
the transceiver subsystem
automatically sends status update requests to persons that are en-route to the facility; and
receives replies to the status update requests from at least some of the persons that are en-route to the facility; and
the tracking subsystem updates estimates of the amount of time it will take the persons en-route to the facility to arrive at the facility, based on the received replies to the status update requests.
